(19) United States
(12) Patent Application Publication
(10) Pub. No.: US 2023/0408131 A1
(43) Pub. Date: Dec. 21, 2023

(54) OUTDOOR AIR PROCESSING APPARATUS

(71) Applicant: Mitsubishi Electric Corporation, Tokyo (JP)

(72) Inventors: Hayato HORIE, Tokyo (JP); Mamoru HAMADA, Tokyo (JP)

(21) Appl. No.: 18/254,629

(22) PCT Filed: Jan. 29, 2021
(86) PCT No.: PCT/JP2021/003358

§ 371 Date: May 26, 2023

(51) Int. Cl. F24F 11/72; F24F 3/14

(52) U.S. Cl. CPC F24F 11/72; F24F 3/14; F24F 2003/144

(57) ABSTRACT

An outdoor air processing apparatus includes a heat exchanger that functions as a heater and as a cooler and that exchanges heat with outdoor air, a desiccant through which the outdoor air passes after the heat has been exchanged by the heat exchanger, and a damper device that selectively sends the outdoor air that has passed the desiccant into one of a first flow path and a second flow path, based on whether the heat exchanger is functioning as the heater or as the cooler.

### CROSS-REFERENCE TO RELATED APPLICATION

This application is a U.S. National Stage Application of International Application No. PCT/JP2021/003358 filed Jan. 29, 2021, the contents of which are incorporated herein by reference.

### TECHNICAL FIELD

The present disclosure relates to an outdoor air processing apparatus that dehumidifies and humidifies outdoor air and supplies the air indoors with using a stationary desiccant.

### BACKGROUND

Conventionally, there is a technique for an air conditioning system that dehumidifies outdoor air and supplies the air indoors with using a rotor-type desiccant (for example, Patent Literature 1).

In Patent Literature 1, when the desiccant is regenerated, that is, in a step of desorbing from the desiccant, moisture adsorbed from the air by the desiccant, return air, which is air exhausted from a room, is heated and led to the desiccant to regenerate the desiccant.

However, when the desiccant is regenerated with using the return air, viruses and dust present in the room adhere to the desiccant. Then, when the outdoor air is passed through the regenerated desiccant, the viruses and dust adhered to the desiccant may return to the room.

### PATENT LITERATURE

Patent Literature 1: JP H11-304194 A

### SUMMARY

The present disclosure uses outdoor air instead of using return air exhausted from a room, as air used to regenerate a desiccant. By using the outdoor air to regenerate the desiccant, it is possible to reduce viruses and dust indoors from adhering to the desiccant and therefore to prevent viruses and dust from re-spreading indoors.

An outdoor air processing apparatus according to the present disclosure includes:
a heat exchanger to function as a heater and as a cooler and to exchange heat with outdoor air;
a stationary dehumidification device through which the outdoor air passes after the heat has been exchanged by the heat exchanger; and
a sending device to selectively send the outdoor air that has passed the stationary dehumidification device into one of a first flow path and a second flow path, based on whether the heat exchanger is functioning as the heater or as the cooler.

According to the present disclosure, outdoor air that has exchanged heat with a heat exchanger that functions as a heater or as a cooler, passes through a stationary dehumidification device. Therefore, a desiccant, which is the stationary dehumidification device, can be regenerated with using the outdoor air that has passed through the heat exchanger. Further, since the outdoor air that has exchanged heat with the heat exchanger that functions as the heater or as the cooler, passes through the stationary dehumidification device, it is possible to realize an outdoor air processing apparatus with using a simple structure.

### BRIEF DESCRIPTION OF DRAWINGS

FIG. 1 is a diagram of Embodiment 1 illustrating an adsorption operation in a dehumidification operation mode.

FIG. 2 is a diagram of Embodiment 1 illustrating a regeneration operation in the dehumidification operation mode.

FIG. 3 is a diagram of Embodiment 1 illustrating the adsorption operation in a humidification operation mode.

FIG. 4 is a diagram of Embodiment 1 illustrating the regeneration operation in the humidification operation mode.

FIG. 5 is a diagram of Embodiment 1 illustrating a refrigeration cycle device 500 having a heat exchanger 10 as a first heat exchanger.

FIG. 6 is a diagram of Embodiment 1 illustrating a hardware configuration of a control device 101.

FIG. 7 is a diagram of Embodiment 1 illustrating air amount control of outdoor air 81 in the dehumidification operation mode.

FIG. 8 is a diagram of Embodiment 1 and is a flowchart illustrating control to change an exhaust timing by detecting a heat load.

FIG. 9 is a diagram of Embodiment 1 and is a flowchart illustrating control to change an exhaust timing by detecting a human.

### DETAILED DESCRIPTION

In the description and drawings of Embodiments, the same or equivalent portions are denoted by the same reference sign. Description of a portion denoted by the same reference sign will be suitably omitted or simplified. In the following embodiments, a “unit” may be read as a “circuit”, “step”, “procedure”, “process”, or “circuitry”, as necessary. Embodiment 1.

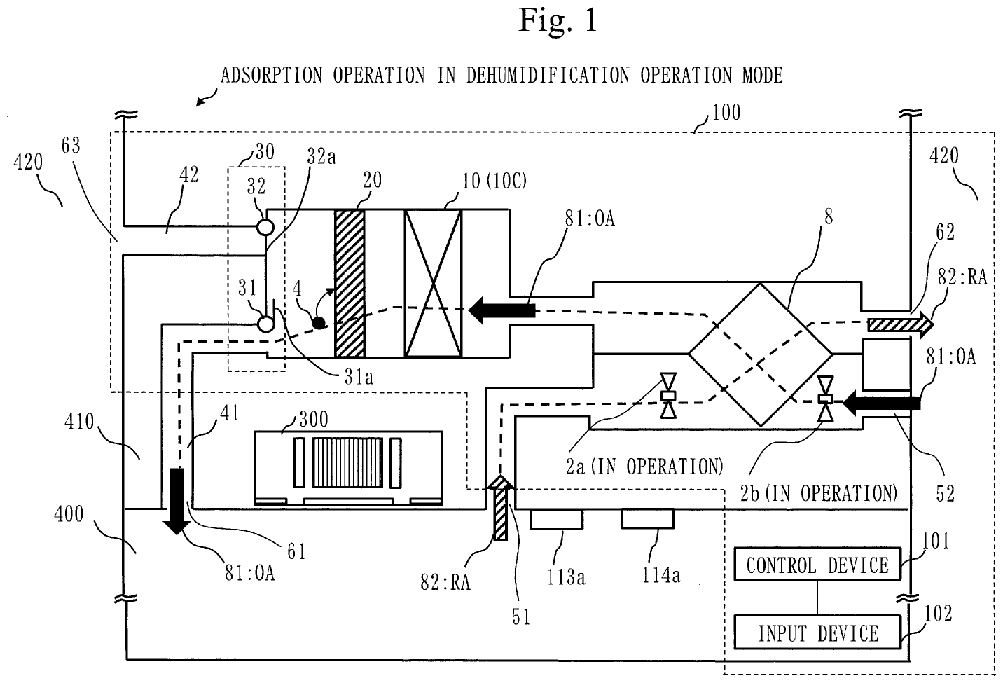

### Description of Configuration The outdoor air processing apparatus 100 of Embodiment 1 will be described with reference to FIGS. 1 to 9.

### Dehumidification Operation Mode and Humidification Operation Mode

There are two types of operation modes for an outdoor air processing apparatus 100. These two types are a dehumidification operation mode that dehumidifies indoors 400 and a humidification operation mode that humidifies the indoors 400. In the dehumidification operation mode, the outdoor air processing apparatus 100 supplies to the indoors 400, outdoor air 81 from which moisture 4 has been excluded by a desiccant 20. In the humidification operation mode, the outdoor air processing apparatus 100 supplies to the indoors 400, the outdoor air 81 to which the moisture 4 has given which has desorbed from the desiccant 20.

### Adsorption Operation and Desorption Operation

Further, there are an adsorption operation and a desorption operation in each operation mode. That is, there are the adsorption operation and the desorption operation in the dehumidification operation mode and there are also the adsorption operation and the desorption operation in the humidification operation mode. The adsorption operation is an operation that causes the desiccant 20 to adsorb the moisture 4 and the desorption operation is an operation that desorbs moisture 4 from the desiccant 20. Since the desorption operation is an operation that desorbs moisture from the desiccant 20, it is sometimes referred to as a “regeneration operation”. In the following, the desorption operation is referred to as the “regeneration operation”.

### Dehumidification Operation Mode

FIG. 1 illustrates the adsorption operation in the dehumidification operation mode of the outdoor air processing apparatus 100.

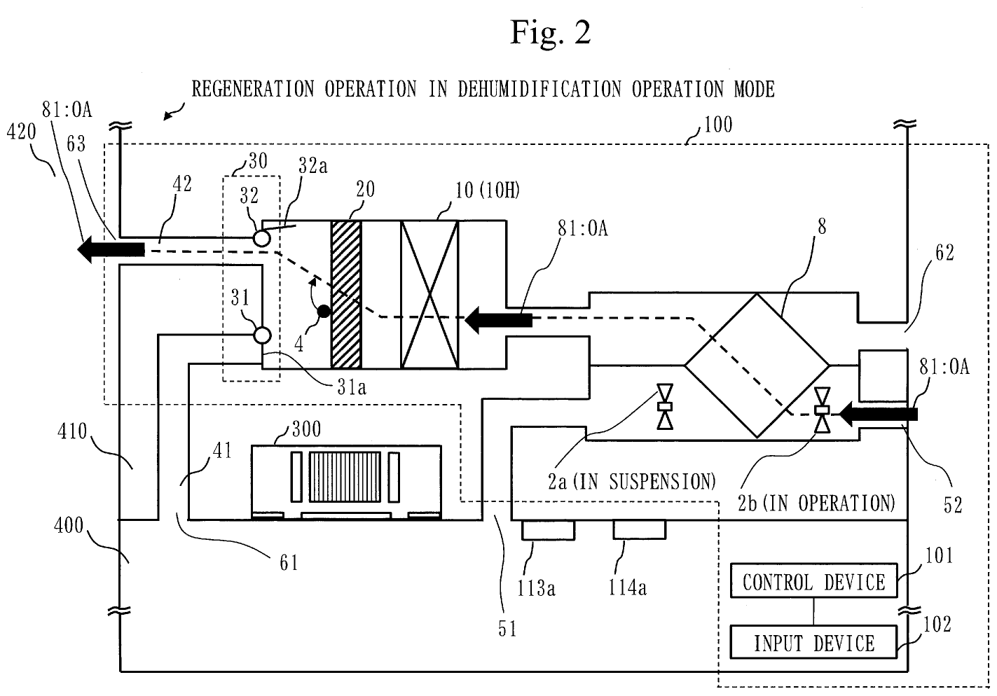

FIG. 2 illustrates the regeneration operation in the dehumidification operation mode of the outdoor air processing apparatus 100.

During the adsorption operation in the dehumidification operation mode, the outdoor air 81 to which the moisture 4 has been adsorbed by the desiccant 20 is supplied to the indoors 400 and return air 82 in the indoors 400 is exhausted to outdoors 420. During the regeneration operation in the dehumidification operation mode, the outdoor air 81 which has acquired the moisture 4 from the desiccant 20 is exhausted to the outdoors 420.

### Configuration of Outdoor Air Processing Apparatus 100

,A configuration of the outdoor air processing apparatus 100 will be described with reference to FIG. 1. The outdoor air processing apparatus 100 includes an exhaust fan 2a, an air supply fan 2b, a total heat exchanger 8, a heat exchanger 10, the desiccant 20, and a damper device 30. The desiccant 20 is a stationary dehumidification device. The damper device 30 is a sending device. The exhaust fan 2a and the air supply fan 2b are installed in the total heat exchanger 8. The exhaust fan 2a sends the return air 82 and the air supply fan 2b sends the outdoor air 81. The heat exchanger 10 functions as a heater and as a cooler, and exchanges heat with the outdoor air 81. The heat exchanger 10 functions either as the heater or as the cooler under control of a device control unit 112 to a refrigeration cycle device 500. When the heat exchanger 10 functions as the heater, it is referred to as a heater 10H. When the heat exchanger 10 functions as the cooler, it is referred to as a cooler 10C. The heat exchanger 10 is installed to exchange heat with the outdoor air 81. The outdoor air 81 that has exchanged heat with the heat exchanger 10 passes through the desiccant 20. When the outdoor air 81 cooled by the cooler 10C passes through the desiccant 20, the desiccant 20 adsorbs the moisture 4 from the outdoor air 81. When the outdoor air 81 heated by the heater 10H passes through the desiccant 20, the desiccant 20 desorbs the moisture 4 to the outdoor air 81. The damper device 30 selectively sends, based on whether the heat exchanger 10 functions as the heater 10H or as the cooler 10C, the outdoor air 81 that has passed through the desiccant 20 into one of a first flow path 41 and a second flow path 42. As described below, in the dehumidification operation mode, the damper device 30 sends the outdoor air 81 that has passed through the desiccant 20 into the second flow path 42 in a case where the heat exchanger 10 is functioning as the heater 10H, and into the first flow path 41 in a case where the heat exchanger 10 is functioning as the cooler 10C. Further, in the humidification operation mode, the damper device 30 sends the outdoor air 81 that has passed through the desiccant 20 into the first flow path 41 in the case where the heat exchanger 10 is functioning as the heater 10H, and into the second flow path 42 in the case where the heat exchanger 10 is functioning as the cooler 10C. The damper device 30 includes a first damper 31 and a second damper 32. The first damper 31 includes a door 31a and the second damper 32 includes a door 32a. The door 31a and the door 32a are open/closed under the control of the device control unit 112.

The heat exchanger 10 and the desiccant 20 are arranged in order downstream of an air path of the outdoor air 81 and the damper device 30 is arranged downstream of the desiccant 20. The first damper 31 opens/closes a path of the first flow path 41 that supplies the outdoor air 81 to the indoors 400. The second damper 32 opens/closes a path of the second flow path 42 that exhausts the outdoor air 81 to the outdoors 420.

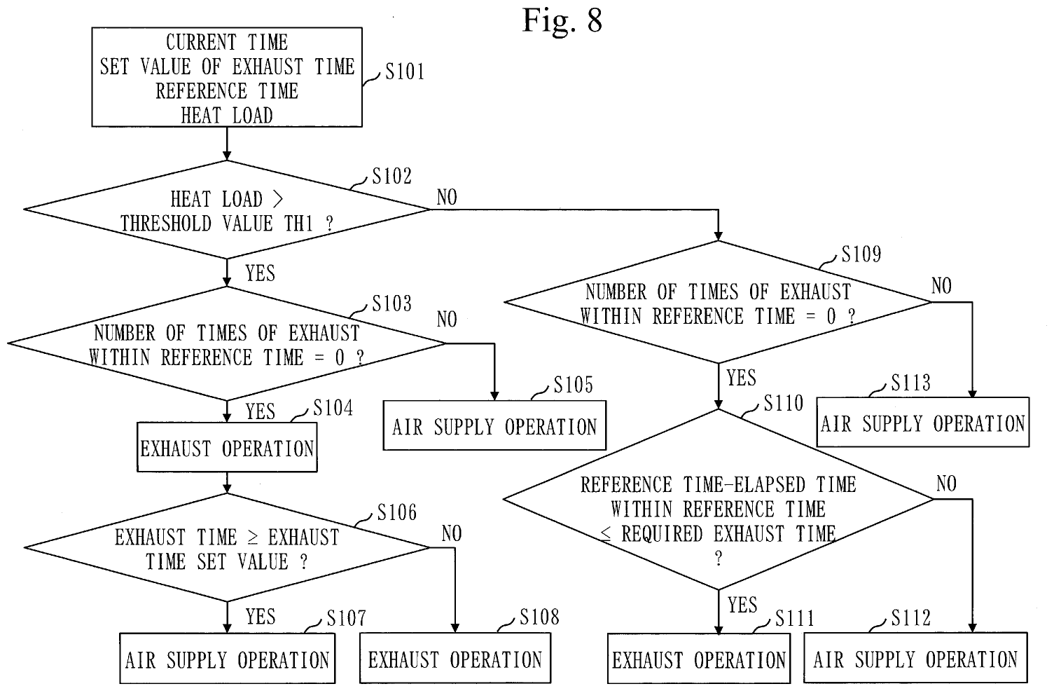

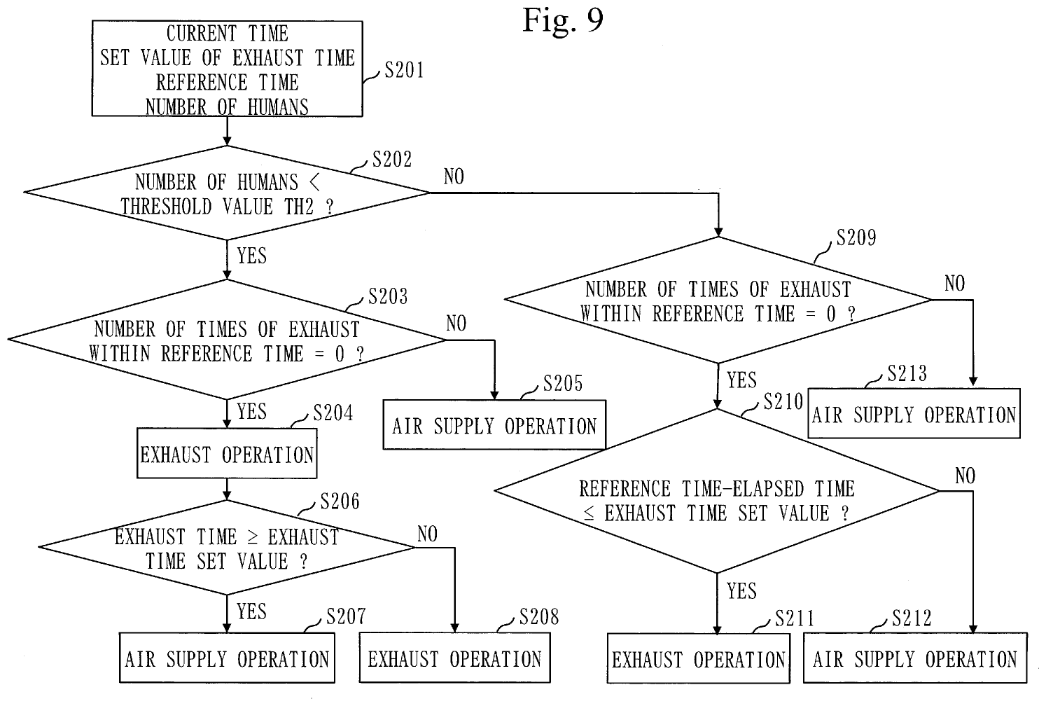

The outdoor air processing apparatus 100 further includes a control device 101 and an input device 102 that inputs information to the control device 101. A user of the outdoor air processing apparatus 100 can input from the input device 102, whether to operate the outdoor air processing apparatus 100 in the dehumidification operation mode or in the humidification operation mode. The outdoor air processing apparatus 100 is installed in a ceiling space 410. An air conditioner 300 is also installed in the ceiling space 410. The air conditioner 300 air-conditions the indoors 400. A temperature sensor 113a and a human sensor 114a are installed in the indoors 400. The temperature sensor 113a is used in control to change an exhaust timing by detecting a heat load, to be described below in FIG. 8. The human sensor 114a is used in control to change an exhaust timing by detecting a human, to be described below in FIG. 9.

The descriptions of FIGS. 1 and 2 are summarized as follows. The damper device 30 sends the outdoor air 81 into a supply flow path as the first flow path 41, that leads to a ventilation area, which is an area to which the outdoor air 81 is supplied and air is exhausted as the outdoor air 81 is supplied, and into a separate area flow path as the second flow path 42, that leads to a separate area that differs from the ventilation area. Here, the indoors 400 is the ventilation area and the outdoors 420 is the separate area that differs from the ventilation area. The outdoor air processing apparatus 100 includes the control device 101. The control device 101 includes an instruction reception unit 111 that receives a dehumidification instruction indicating the dehumidification operation mode via the input device 102, and includes the device control unit 112 that causes the heat exchanger 10 to function either as the heater 10H or as the cooler 10C and also controls the damper device 30. When the instruction reception unit 111 has received the dehumidification instruction, in response to that the device control unit 12 causes the heat exchanger 10 to function as the heater 10H, the device control unit 112 causes the damper device 30 to send the outdoor air 81 into the second flow path 42, which is the separate area flow path, and in response to that the device control unit 12 causes the heat exchanger 10 to function as the cooler 10C, the device control unit 112 causes the damper device 30 to send the outdoor air 81 into the first flow path 41, which is the supply flow path.

### Humidification Operation Mode

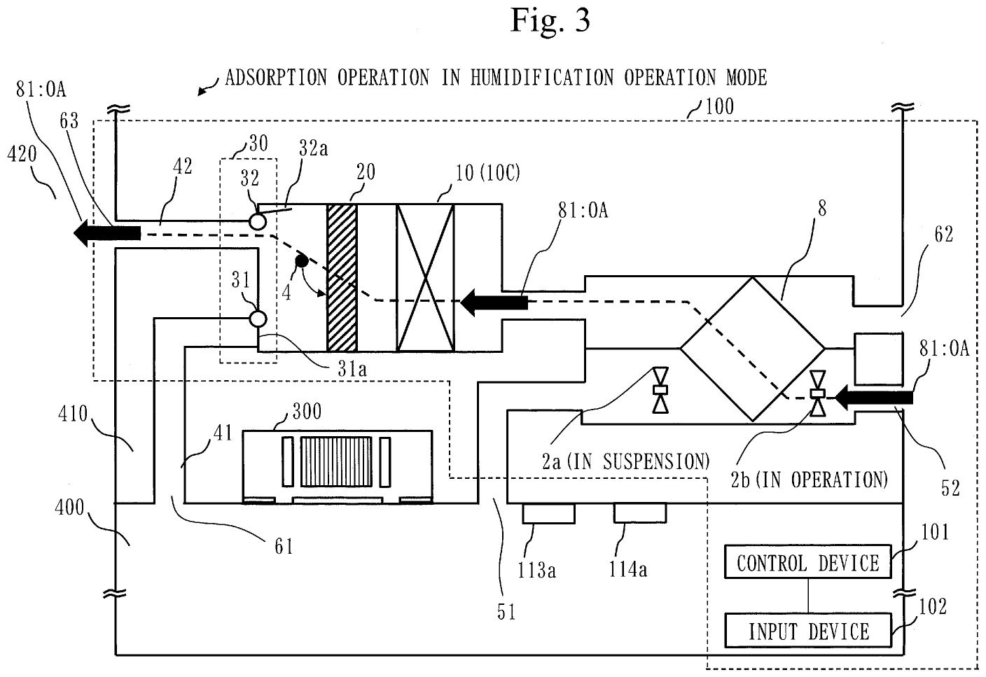

FIG. 3 illustrates the adsorption operation in the humidification operation mode of the outdoor air processing apparatus 100.

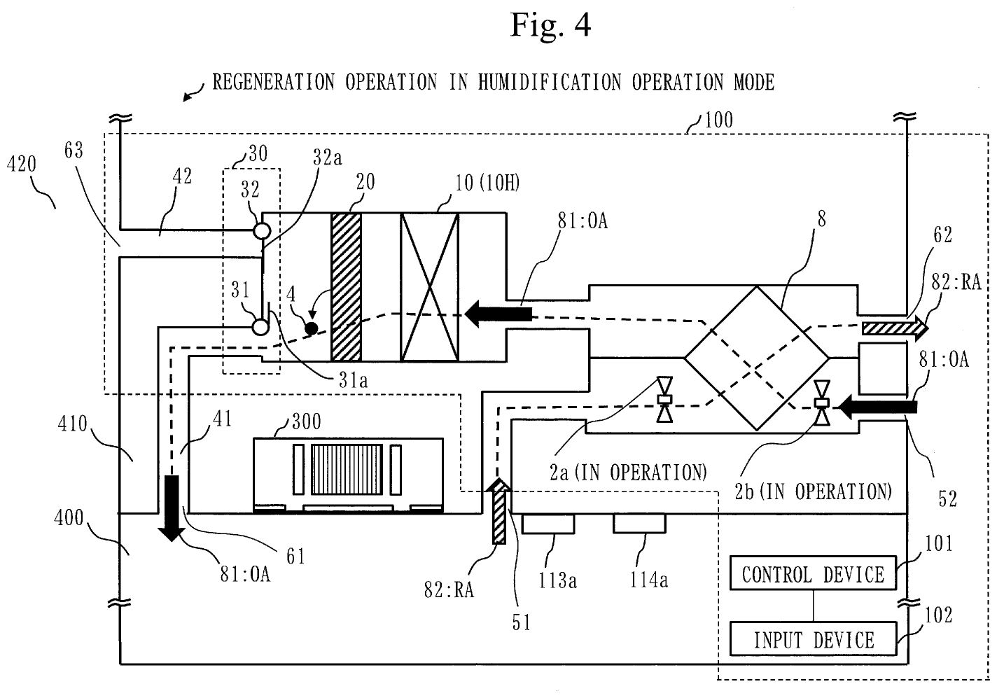

FIG. 4 illustrates the regeneration operation in the humidification operation mode of the outdoor air processing apparatus 100.

Configurations of FIGS. 3 and 4 are the same as those of FIGS. 1 and 2, but a flow direction of the outdoor air 81 and a flow direction of the return air 82 are different. During the adsorption operation in the humidification operation mode, the outdoor air 81 to which the moisture 4 has been adsorbed by the desiccant 20 is exhausted to the outdoors 420. During the regeneration operation in the humidification operation mode, the outdoor air 81 which has acquired the moisture 4 from the desiccant 20 is supplied to the indoors 400 and the return air 82 in the indoors 400 is exhausted to the outdoors 420.

The descriptions of FIGS. 3 and 4 are summarized as follows. The instruction reception unit 111 receives via the input device 102, a humidification instruction indicating the humidification operation mode. When the instruction reception unit 111 has received the humidification instruction, in response to that the device control unit 12 causes the heat exchanger 10 to function as the heater 10H, the device control unit 112 causes the damper device 30 to send the outdoor air 81 into the first flow path 41, which is the supply flow path, and in response to that the device control unit 12 causes the heat exchanger 10 to function as the cooler 10C, the device control unit 12 causes the damper device 30 to send the outdoor air 81 into the second flow path 42, which is the separate area flow path.

### Refrigeration Cycle Device 500

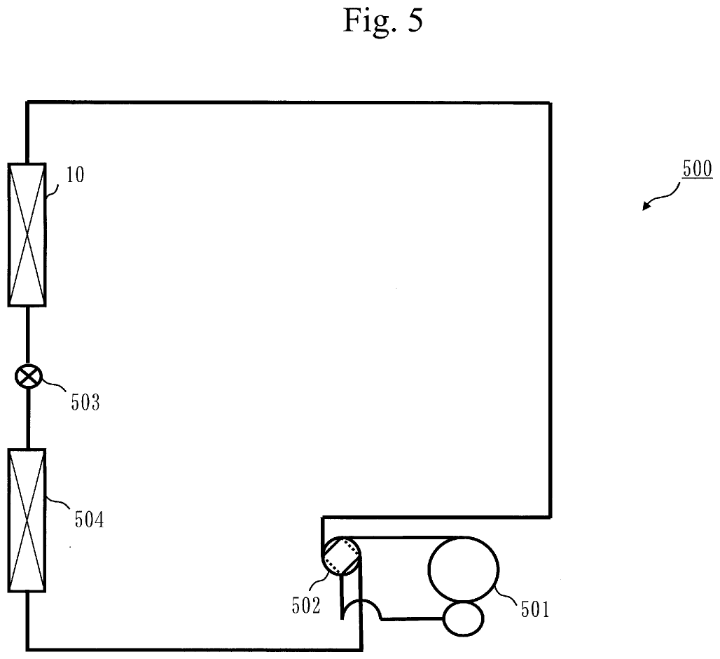

FIG. 5 illustrates the refrigeration cycle device 500 for the heat exchanger 10 to function as the heater 10H and as the cooler 10C. The refrigeration cycle device 500 includes a compressor 501, a four-way valve 502, the heat exchanger 10, which is a first heat exchanger, an expansion valve 503, and a second heat exchanger 504. The device control unit 112 of the control device 101 switches the four-way valve 502, so that the heat exchanger 10 functions either as the heater 10H or as the cooler 10C. Further, the device control unit 112 controls a frequency of the compressor 501 to control a temperature of the heat exchanger 10.

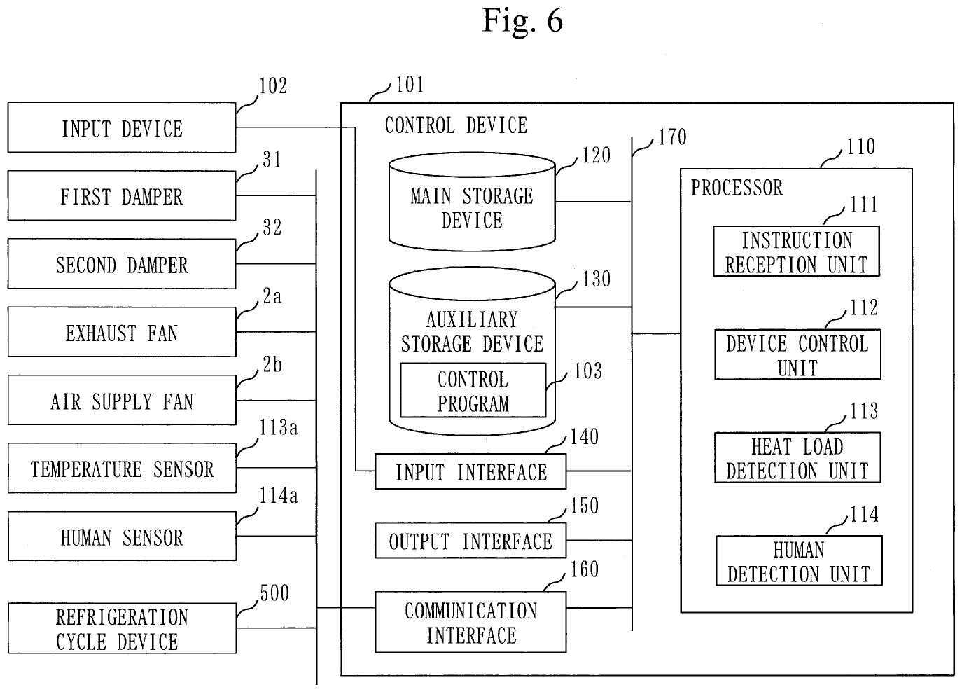

FIG. 6 illustrates a hardware configuration of the control device 101. The control device 101 is a computer. The control device 101 includes a processor 110. The control device 101 includes, in addition to the processor 110, other pieces of hardware such as a main storage device 120, an auxiliary storage device 130, an input interface 140, an output interface 150, and a communication interface 160. The processor 110 is connected to the other pieces of hardware via a signal line 170 and controls the other pieces of hardware.

The control device 101 includes the instruction reception unit 111, the device control unit 112, a heat load detection unit 113, and a human detection unit 114, as functional components. Functions of the instruction reception unit 111, the device control unit 112, the heat load detection unit 113, and the human detection unit 114 are implemented by a control program 103.

The processor 110 is a device that executes the control program 103. The control program 103 is a program that implements the functions of the instruction reception unit 111, the device control unit 112, the heat load detection unit 113, and the human detection unit 114. The processor 110 is an Integrated Circuit (IC) that performs arithmetic processing. A specific example of the processor 110 is a Central Processing Unit (CPU), a Digital Signal Processor (DSP), or a Graphics Processing Unit (GPU).

The main storage device 120 stores data in a volatile manner. A specific example of the main storage device 120 is a Static Random Access Memory (SRAM) or a Dynamic Random Access Memory (DRAM). The main storage device 120 retains arithmetic results of the processor 110.

The auxiliary storage device 130 stores data in a non-volatile manner. A specific example of the auxiliary storage device 130 is a Hard Disk Drive (HDD). Further, the auxiliary storage device 130 may be a portable recording medium such as a Secure Digital (SD) (registered trademark) memory card, NAND flash, a flexible disk, an optical disc, a compact disc, a Blu-ray (registered trademark) disc, or a Digital Versatile Disk (DVD). The auxiliary storage device 130 stores the control program 103.

The input interface 140 is a port to which data is input from each device. The output interface 150 is a port to which each of various devices is connected and from which data is output by the processor 110 to each of the various devices. The input interface 140 is connected to the input device 102.

The communication interface 160 is a communication port for the processor 110 to communicate with another device. The first damper 31, the second damper 32, the exhaust fan 2a, the air supply fan 2b, the temperature sensor 113a, a human sensor 114a, and the refrigeration cycle device 500 are connected to the communication interface 160.

The processor 110 loads the control program 103 from the auxiliary storage device 130 to the main storage device 120, reads the control program 103 from the main storage device 120, and executes the read control program 103. The control device 101 may include a plurality of processors in place of the processor 110. The plurality of these processors shares execution of the control program 103. Each of the plurality of processors is, like the processor 110, a device that executes the control program 103. Data, information, a signal value, and a variable value that are used, processed, or output by the control program 103 are stores in the main storage device 120, the auxiliary storage device 130, or stored in a register or a cache memory in the processor 110.

The control program 103 is a program that causes the computer to execute each process, each procedure, or each step, where “unit” in each of the instruction reception unit 111, the device control unit 112, the heat load detection unit 113, and the human detection unit 114 is interpreted as “process”, “procedure”, or “step”.

Further, a control method is a method to be performed by the control device 101 as the computer executing the control program 103. The control program 103 may be provided as being stored in a computer readable recording medium or may be provided as a program product.

### Description of Operation

### A1. Adsorption Operation in Dehumidification Operation Mode

The adsorption operation in the dehumidification operation mode will be described with reference to FIG. 1. As illustrated in FIG. 1, during the adsorption operation, the device control unit 112 operates both of the exhaust fan 2a and the air supply fan 2b.

(1) The total heat exchanger 8:
The outdoor air 81 is sucked from an outdoor air suction port 52 into the air supply fan 2b and passes through the total heat exchanger 8. At this time, the outdoor air 81 exchanges heat with the return air 82 that passes through the total heat exchanger 8.
(2) The heat exchanger 10 (the cooler 10C):
The outdoor air 81 that has passed through the total heat exchanger 8 is cooled down by exchanging heat with the heat exchanger 10 that is functioning as the cooler 10C under the control of the device control unit 112, so that a relative humidity is increased.
(3) The desiccant 20:
The outdoor air 81 with the high relative humidity passes through the desiccant 20. At this time, the desiccant 20 adsorbs the moisture 4 from the outdoor air 81.
(4) The damper device 30:
Under the control of the device control unit 112, the door 31a of the first damper 31 is open and the door 32a of the second damper 32 is closed. The outdoor air 81 dehumidified by the desiccant 20 passes through the first damper 31, is sent into the first flow path 41, and is supplied from an outdoor air supply port 61 to the indoors 400.
(5) The return air 82:
The device control unit 112 operates the exhaust fan 2a. The return air 82 in the indoors 400 is sucked into a return air suction port 51, passes through the exhaust fan 2a and the total heat exchanger 8, and is exhausted from a return air exhaust port 62 to the outdoors 420.

### A2. Regeneration Operation in Dehumidification Operation Mode

The regeneration operation in the dehumidification operation mode will be described with reference to FIG. 2. The regeneration operation is as follows. As illustrated in FIG. 2, during the regeneration operation, the device control unit 112 suspends the exhaust fan 2a and operates the air supply fan 2b only. Further, the device control unit 112 causes the heat exchanger 10 to function as the heater 10H.

(1) The total heat exchanger 8:
The outdoor air 81 is sucked from the outdoor air suction port 52 into the air supply fan 2b and passes through the total heat exchanger 8. As described below, since the return air 82 in the indoors 400 is not exhausted, the outdoor air 81 does not exchange heat with the return air 82 in the total heat exchanger 8.
(2) The heat exchanger 10 (the heater 10H):
The outdoor air 81 hat has passed through the total heat exchanger 8 is heated by exchanging heat with the heat exchanger 10 that is functioning as the heater 10H under the control of the device control unit 112, so that the relative humidity is decreased.
(3) The desiccant 20:
The outdoor air 81 with the low relative humidity passes through the desiccant 20. At this time, the moisture 4 adsorbed to the desiccant 20 desorbs to the outdoor air 81.
(4) The damper device 30: Under the control of the device control unit 112, the door 31a of the first damper 31 is closed and the door 32a of the second damper 32 is open. The outdoor air 81 humidified by the desiccant 20 passes through the second damper 32, is sent into the second flow path 42, and is exhausted from an outdoor air exhaust port 63 to the outdoors 420.
(5) Since the exhaust fan 2a is in a suspension state, the return air 82 in the indoors 400 is not exhausted from the return air exhaust port 62.

### B1. Adsorption Operation in Humidification Operation Mode

The adsorption operation in the humidification operation mode will be described with reference to FIG. 3. As illustrated in FIG. 3, during the adsorption operation, the device control unit 112 suspends the exhaust fan 2a and operates the air supply fan 2b only.

(1) The total heat exchanger 8:
The outdoor air 81 is sucked from the outdoor air suction port 52 into the air supply fan 2b and passes through the total heat exchanger 8.
(2) The heat exchanger 10 (the cooler 10C):
The outdoor air 81 that has passed through the total heat exchanger 8 is cooled down by exchanging heat with the heat exchanger 10 that is functioning as the cooler 10C under the control of the device control unit 112, so that the relative humidity is increased.
(3) The desiccant 20:
The outdoor air 81 with the high relative humidity passes through the desiccant 20. At this time, the desiccant 20 adsorbs the moisture 4 from the outdoor air 81.
(4) The damper device 30:
Under the control of the device control unit 112, the door 31a of the first damper 31 is closed and the door 32a of the second damper 32 is open. The outdoor air 81 dehumidified by the desiccant 20 passes through the second damper 32, is sent into the second flow path 42, and is supplied from the outdoor air exhaust port 63 to the outdoors 420.
(5) The return air 82: Since the exhaust fan 2a is in the suspension state, the return air 82 in the indoors 400 is not exhausted from the return air exhaust port 62.

### B2. Regeneration Operation in Humidification Operation Mode

The regeneration operation in the humidification operation mode will be described with reference to FIG. 4. As illustrated in FIG. 4, during the regeneration operation, the device control unit 112 operates both of the exhaust fan 2a and the air supply fan 2b.

(1) The total heat exchanger 8:
The outdoor air 81 is sucked from the outdoor air suction port 52 into the air supply fan 2b and passes through the total heat exchanger 8. At this time, the outdoor air 81 exchanges heat with the return air 82 that passes through the total heat exchanger 8.
(2) The heat exchanger 10 (the heater 10H):
The outdoor air 81 that has passed through the total heat exchanger 8 is heated by exchanging heat with the heat exchanger 10 that is functioning as the heater 10H under the control of the device control unit 112, so that the relative humidity is decreased.
(3) The desiccant 20:
The outdoor air 81 with the low relative humidity passes through the desiccant 20. At this time, the moisture 4 adsorbed to the desiccant 20 desorbs to the outdoor air 81.
(4) The damper device 30:
Under the control of the device control unit 112, the door 31a of the first damper 31 is open and the door 32a of the second damper 32 is closed. The outdoor air 81 humidified by the desiccant 20 passes through the first damper 31, is sent into the first flow path 41, and is supplied from the outdoor air supply port 61 to the indoors 400.
(5) The return air 82:
The device control unit 112 operates the exhaust fan 2a. The return air 82 in the indoors 400 is sucked into the return air suction port 51, passes through the exhaust fan 2a and the total heat exchanger 8, and is exhausted from the return air exhaust port 62 to the outdoors 420.

### A3. Adjustment of Air Supply Amount in Dehumidification Operation Mode

Depending on an air amount of outdoor air sent by the damper device 30 into the second flow path 42, which is the separate area flow path, the device control unit 112 controls an air amount of the outdoor air 81 sent by the damper device 30 into the first flow path 41, which is the supply flow path. The description will be specifically given below.

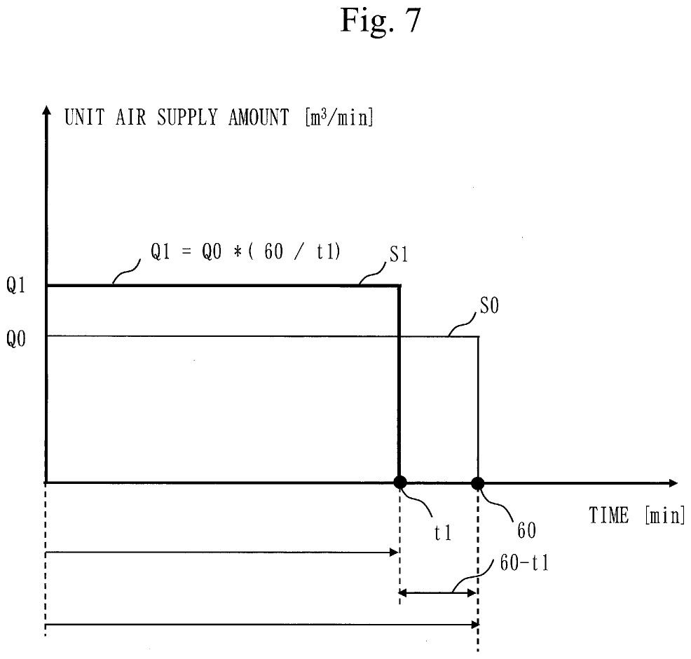

FIG. 7 is a diagram illustrating air amount control of the outdoor air 81 in the dehumidification operation mode. The horizontal axis indicates a supply time of the outdoor air 81 to the indoors 400. The unit is a minute (min). The vertical axis indicates a unit air supply amount. The unit air supply amount is an air supply amount of the outdoor air 81 to the indoors 400 per minute. The unit is m³/min. As illustrated in FIG. 7, in consideration of a ventilation suspension time (an exhaust suspension period of the return air 82) during the regeneration operation in the dehumidification operation mode, the outdoor air processing apparatus 100 adjusts the air supply amount to satisfy a required ventilation amount per unit time. The device control unit 112 controls the number of rotations of the air supply fan 2b, so that during the adsorption operation in the dehumidification operation mode, a suction amount of the outdoor air 81 from the outdoor air suction port 52, which is the air supply amount, is adjusted. The explanation will be specifically given with using one hour as a reference time. In consideration of a ventilation suspension time (60-t1 in FIG. 7) during the regeneration operation of FIG. 2 for a required ventilation amount QO for one hour, the air amount is set as Equation 1 below regarding an air amount Q1 during the adsorption operation. As a result, it is possible to satisfy the required ventilation amount per reference time.

Q0×60÷t1 (Equation 1)

The air amount Q1 is calculated as follows. In FIG. 7, the area of a rectangle S0 and the area of a rectangle S1 are supposed to be equal. It is assumed that the unit of the air amount is m³/min. An air amount Qa supplied in one reference hour at the air amount Q0 is calculated by Equation 2.

Qa=Q0(m³/min)×60(min) (Equation 2)

An air amount Qb supplied in t1(min) within one reference hour at the air amount Q1 is calculated by Equation 3.

Qb=Q1(m³/min)×t1(min) (Equation 3)

### Since Qa=Qb,

Q0×60=Q1×t1

Therefore, Q1 is calculated by Equation 4.

Q1=Q0×(60/t1) (Equation 4)

### A3.1

When adjusting the air supply amount in the dehumidification operation mode, in order to adjust a time of the regeneration operation (FIG. 2) to exhaust the outdoor air 81 to the outdoors 420, by controlling the refrigeration cycle device 500, the device control unit 112 may control a heat amount for the outdoor air 81 by the heater 10H during the regeneration operation. As a result, since the period of “60-t1” in FIG. 7 can be accurately acquired, it is possible to control the ventilation amount more accurately.

### A3.2

In the dehumidification operation mode, a timing to start the regeneration operation to exhaust the outdoor air 81 may be decided by such as a timer or a time point within the reference time (one hour in the above example), for example, if twelve o'clock is included within the reference time, twelve o'clock is used as the time point. In the following, terms of an exhaust operation and an air supply operation are used. These terms have the following meanings. The exhaust operation is an operation that exhausts the outdoor air 81 that has passed the desiccant 20, from the second flow path 42 to the outdoors 420. The air supply operation is an operation that supplies the outdoor air 81 that has passed the desiccant 20, from the first flow path 41 to the indoors 400. In the dehumidification operation mode, the exhaust operation is the regeneration operation of FIG. 2. In the humidification operation mode, the exhaust operation is the adsorption operation of FIG. 3. In the dehumidification operation mode, the air supply operation is the adsorption operation of FIG. 1. In the humidification operation mode, the air supply operation is the regeneration operation of FIG. 4. Since the description here is regarding the dehumidification operation mode, the exhaust operation is the regeneration operation. For example, a load is high for an air conditioning system in the morning because the air conditioning system is started to operate. For this reason, it is considered that the outdoor air processing apparatus 100 operates the exhaust operation to reduce the ventilation amount. That is, the return air 82 in the indoors 400 is not exhausted to the outdoors 420 in the exhaust operation, so that air in the indoors 400 without being ventilated, is controlled by the air conditioning system to approach to a set temperature. Therefore, the load is low for the air conditioning system.

### B3. Adjustment of Air Supply Amount in Humidification Operation Mode

An adjustment of the air supply amount in the humidification operation mode is the same as for the air supply amount in the dehumidification operation mode. In the humidification operation mode, the outdoor air 81 is supplied to the indoors 400 during the regeneration operation and the outdoor air 81 is exhausted to the outdoors 420 during the adsorption operation. Therefore, the adjustment of the air supply amount in the humidification operation mode is executed during the regeneration operation.

### B3.1

When adjusting the air supply amount in the humidification operation mode, in order to adjust a time of the adsorption operation to exhaust the outdoor air 81 to the outdoors 420, by controlling the refrigeration cycle device 500, the device control unit 112 may control cooling for the outdoor air 81 by the cooler 10C during the adsorption operation. As a result, since the period of “60-t1” in FIG. 7 can be accurately acquired, it is possible to control the ventilation amount more accurately.

### B3.2

In the humidification operation mode, a timing to start the adsorption operation to exhaust the outdoor air 81 may be decided by such as a timer or a time point within the reference time (one hour in the above example), for example, if twelve o'clock is included within the reference time, twelve o'clock is used as the time point. Since the description here is regarding the humidification operation mode, the exhaust operation is the adsorption operation. For example, a load is high for an air conditioning system in the morning because the air conditioning system is started to operate. For this reason, it is considered that the outdoor air processing apparatus 100 operates the exhaust operation to reduce the ventilation amount. That is, the return air 82 in the indoors 400 is not exhausted to the outdoors 420 in the exhaust operation, so that air in the indoors 400 without being ventilated, is controlled by the air conditioning system to approach to a set temperature. Therefore, the load is low for the air conditioning system.

FIG. 8 is a flowchart illustrating operation of the outdoor air processing apparatus 100 in a case where the outdoor air processing apparatus 100 includes the heat load detection unit 113. The control device 101 includes the heat load detection unit 113 that detects a heat load of the air conditioner 300 that air-conditions the indoors 400, which is the ventilation area. When the detected heat load is greater than a threshold value, the device control unit 112 causes the damper device 30 to send the outdoor air 81 into the second flow path 42, which is the separate area flow path. The description will be specifically given below. The heat load detection unit 113 is connected to the temperature sensor 113a via the communication interface 160 and detects a temperature Ti of the indoors 400 from the temperature sensor 113a. Further, the heat load detection unit 113 acquires from an air conditioning control device that controls the air conditioner 300 and is not illustrated, a set temperature Ts of the indoors 400 for the air conditioner 300, via the communication interface 160.

The heat load detection unit 113 detects the heat load to be processed by the air conditioner 300. The heat load here is a difference ΔT between the set temperature Ts acquired by the heat load detection unit 113 and a temperature Ti of the indoors 400 detected by the heat load detection unit 113 via the temperature sensor 113a. ΔT is calculated with using Equation 5.
ΔT will be described below as the heat load.

ΔT=|Ti−Ts| (Equation 5)

### Step S101

In step S101, the instruction reception unit 111 acquires a current time, a set value (equivalent to “60-t1” in FIG. 7) of an exhaust time, and the reference time (equivalent to one hour in FIG. 7). The heat load detection unit 113 calculates the heat load ΔT.

### Step S102

The heat load detection unit 113 determines whether or not the heat load ΔT is greater than a threshold value TH1. When the heat load ΔT is greater, the process proceeds to step S103. Otherwise, the process proceeds to step S109.

### Step S103

In step S103, the device control unit 112 determines whether or not the exhaust operation (the regeneration operation in the dehumidification operation mode and the adsorption operation in the humidification operation mode) is operated within the reference time. When the exhaust operation is not operated within the reference time, the process proceeds to step S104. When the exhaust operation is operated within the reference time, the process proceeds to step S105.

### Step S104

In step S104, the device control unit 112 performs the exhaust operation. The exhaust operation is the regeneration operation in the dehumidification operation mode and the adsorption operation in the humidification operation mode. Depending on the exhaust operation, it is possible to reduce an increase in the heat load due to an increase in the ventilation amount.

In step S105, the device control unit 112 performs the air supply operation. The air supply operation is the adsorption operation in the dehumidification operation mode and the regeneration operation in the humidification operation mode.

In step S106, the device control unit 112 determines whether or not the exhaust time (equivalent to “60-t1”), which is a time of the exhaust operation, is greater than or equal to an exhaust time set value. When YES in step S106, the process proceeds to step S107. When NO in step S106, the process proceeds to step S108.

### Step S107

In step S107, the device control unit 112 starts the air supply operation of the outdoor air 81. The air supply operation is the adsorption operation in the dehumidification operation mode and the regeneration operation in the humidification operation mode.

### Step S108

In step S108, the device control unit 112 continues the exhaust operation from step S104. The exhaust operation is the regeneration operation in the dehumidification operation mode and the adsorption operation in the humidification operation mode.

### Step S109

In step S109, the device control unit 112 determines whether or not the exhaust operation is performed within the reference time (for example, within 60 minutes). The exhaust operation is the regeneration operation in the dehumidification operation mode and the adsorption operation in the humidification operation mode. When the exhaust operation is not performed within the reference time, the process proceeds to step S110. When the exhaust operation is performed within the reference time, the process proceeds to step S113.

### Step S110

In step S110, when a remaining time (an elapsed time within the reference time) of the reference time (60 minutes) is less than or equal to a required exhaust operation time (YES in step S110), the device control unit 112 shifts to the exhaust operation in step S111. The exhaust operation is the regeneration operation in the dehumidification operation mode and the adsorption operation in the humidification operation mode. In step S110, when the remaining time (the elapsed time within the reference time) of the reference time (60 minutes) is greater than the required exhaust operation time (NO in step S110), the device control unit 112 continues the air supply operation in step S112.

FIG. 9 is a flowchart illustrating operation of the outdoor air processing apparatus 100 that includes the human detection unit 114. The control device 101 includes the human detection unit 114 that detects the number of humans present in the indoors 400, which is the ventilation area. When the number of humans detected by the human detection unit 114 is less than a threshold value TH2, the device control unit 112 causes the damper device 30 to send the outdoor air 81 into the second flow path 42, which is the separate area flow path. The description will be specifically given below. The human detection unit 114 is connected to the human sensor 114a via the communication interface 160 and detects from the human sensor 114a, the number of humans present in the indoors 400. FIG. 9 is similar to FIG. 8. Step S201 to step S212 respectively correspond to step S101 to step S112. Step S203 to step S212 are respectively the same processes as step S103 to step S112, except that steps S201 and S202 differ from steps S101 and S102. Accordingly, steps S201 and S202 will be described.

### Steps S201 and S202

In step S201, the instruction reception unit 111 acquires the current time, the set value of the exhaust time, and the reference time. The human detection unit 114 acquires the number of humans from the human sensor 114a. The human detection unit 114 detects the number of humans present in the indoors 400 via the human sensor 114a.

### Step S202

The human detection unit 114 determines whether or not the detected number of humans is less than the threshold value TH2. When the detected number of humans is less, the process proceeds to step S203. Otherwise, the process proceeds to step S209. Since the following processes are the same as those in FIG. 8 as described above, the description thereof is omitted.

### Description of Effect of Embodiment 1

The outdoor air processing apparatus 100 in Embodiment 1 regenerates the desiccant 20 without using the return air 82. For this reason, it is possible to reduce viruses and dust present in the indoors 400 from adhering to the desiccant 20. This prevents viruses and dust from spreading indoors and it is possible to efficiently exhaust viruses and dust.

Further, the outdoor air processing apparatus 100 adjusts the air amount in consideration of the ventilation suspension time during the exhaust operation to exhaust the outdoor air 81 to the outdoors 420. For this reason, it is possible to satisfy the required ventilation amount per unit time.

Consequently, it is possible to provide a healthy and comfortable space.

,Further, it is possible to operate the exhaust operation such as an operation of suspending ventilation to reduce a peak of a heat load of an air conditioning system, by providing a heat load detection means, or an operation of suspending ventilation at a timing of giving no feeling of unpleasant to a resident, by providing a human detection means. Therefore, convenience is improved.

Further, the device control unit 112 of the outdoor air processing apparatus 100 controls opening/closing the door 31a and the door 32a of the damper device 30 depending on whether the heat exchanger 10 is functioning as the heater 10H or the cooler 10C, so that it is possible to realize the outdoor air processing apparatus 100 with using a simple structure.

1. An outdoor air processing apparatus comprising:
a heat exchanger to function as a heater and as a cooler and to exchange heat with outdoor air;
a stationary dehumidification device through which the outdoor air passes after the heat has been exchanged by the heat exchanger; and
a sending device to selectively send the outdoor air that has passed the stationary dehumidification device into one of a first flow path and a second flow path, based on whether the heat exchanger is functioning as the heater or as the cooler, wherein
the sending device sends the outdoor air into a supply flow path as the first flow path, that leads to a ventilation area, which is an area to which the outdoor air is supplied and air is exhausted as the outdoor air is supplied, and sends the outdoor air into a separate area flow path as the first flow path, that leads to a separate area that differs from the ventilation area, and
the outdoor air processing apparatus further comprises a control device, wherein
the control device comprises processing circuitry to control the sending device, and to cause the heat exchanger to function either as the heater or as the cooler, wherein
in response to that the processing circuitry causes the heat exchanger to function as the heater, the processing circuitry causes the sending device to send the outdoor air into the separate area flow path, and in response to that the processing circuitry causes the heat exchanger to function as the cooler, the processing circuitry causes the sending device to send the outdoor air into the supply flow path, and
the processing circuitry controls an air amount of the outdoor air to be sent into the supply flow path by the sending device, depending on the air amount of the outdoor air to be sent into the separate area flow path by the sending device.

2. The outdoor air processing apparatus according to claim 1, wherein
the processing circuitry:
receives one of a dehumidification instruction indicating a dehumidification operation and a humidification instruction indicating a humidification operation, and
when the processing circuitry has received the dehumidification instruction, in response to that the processing circuitry causes the heat exchanger to function as the heater, the processing circuitry causes the sending device to send the outdoor air into the separate area flow path, and in response to that the processing circuitry causes the heat exchanger to function as the cooler, the processing circuitry causes the sending device to send the outdoor air into the supply flow path, and
when the processing circuitry has received the humidification instruction, in response to that the processing circuitry causes the heat exchanger to function as the heater, the processing circuitry causes the sending device to send the outdoor air into the supply flow path, and in response to that the processing circuitry causes the heat exchanger to function as the cooler, the processing circuitry causes the sending device to send the outdoor air into the separate area flow path.

3. (canceled)

4. (canceled)

5. (canceled)

6. (canceled)

7. An outdoor air processing apparatus comprising:
a heat exchanger to function as a heater and as a cooler and to exchange heat with outdoor air;
a stationary dehumidification device through which the outdoor air passes after the heat has been exchanged by the heat exchanger; and
a sending device to selectively send the outdoor air that has passed the stationary dehumidification device into one of a first flow path and a second flow path, based on whether the heat exchanger is functioning as the heater or as the cooler, wherein
the sending device sends the outdoor air into a supply flow path as the first flow path, that leads to a ventilation area, which is an area to which the outdoor air is supplied and air is exhausted as the outdoor air is supplied, and sends the outdoor air into a separate area flow path as the second flow path, that leads to a separate area that differs from the ventilation area, and
the outdoor air processing apparatus further comprises a control device, wherein
the control device comprises processing circuitry to control the sending device, and to cause the heat exchanger to function either as the heater or as the cooler, wherein
in response to that the processing circuitry causes the heat exchanger to function as the heater, the processing circuitry causes the sending device to send the outdoor air into the separate area flow path, and in response to that the processing circuitry causes the heat exchanger to function as the cooler, the processing circuitry causes the sending device to send the outdoor air into the supply flow path,
the processing circuitry detects a heat load of an air conditioner that air-conditions the ventilation area, and
the processing circuitry causes the sending device to send the outdoor air into the separate area flow path when the detected heat load is greater than a threshold value.

8. An outdoor air processing apparatus comprising:
a heat exchanger to function as a heater and as a cooler and to exchange heat with outdoor air;
a stationary dehumidification device through which the outdoor air passes after the heat has been exchanged by the heat exchanger; and
a sending device to selectively send the outdoor air that has passed the stationary dehumidification device into one of a first flow path and a second flow path, based on whether the heat exchanger is functioning as the heater or as the cooler, wherein
the sending device sends the outdoor air into a supply flow path as the first flow path, that leads to a ventilation area, which is an area to which the outdoor air is supplied and air is exhausted as the outdoor air is supplied, and sends the outdoor air into a separate area flow path as the second flow path, that leads to a separate area that differs from the ventilation area, and
the outdoor air processing apparatus further comprises a control device, wherein
the control device comprises processing circuitry to control the sending device, and to cause the heat exchanger to function either as the heater or as the cooler, wherein
in response to that the processing circuitry causes the heat exchanger to function as the heater, the processing circuitry causes the sending device to send the outdoor air into the separate area flow path, and in response to that the processing circuitry causes the heat exchanger to function as the cooler, the processing circuitry causes the sending device to send the outdoor air into the supply flow path,
the processing circuitry detects the number of humans present in the ventilation are, and the processing circuitry causes the sending device to send the outdoor air into the separate area flow path when the detected number of humans is less than a threshold value.
